(19) United States
(12) Patent Application Publication
(10) Pub. No.: US 2023/0309439 A1
(43) Pub. Date: Oct. 5, 2023

(54) FARMING FIELD INFORMATION MANAGEMENT DEVICE, FARMING FIELD INFORMATION MANAGEMENT SYSTEM, FARMING FIELD INFORMATION MANAGEMENT METHOD, AND STORAGE MEDIUM STORING FARMING FIELD INFORMATION MANAGEMENT PROGRAM

(71) Applicant: TOPCON CORPORATION, Tokyo (JP)

(72) Inventors: Kaede YARIMIZU, Tokyo (JP); Tatsuya MUROFUSHI, Tokyo (JP); Ken KOMATSU, Tokyo (JP)

(73) Assignee: TOPCON CORPORATION, Tokyo (JP)

(21) Appl. No.: 18/186,905

(22) Filed: Mar. 20, 2023

(30) Foreign Application Priority Data
Mar. 30, 2022 (JP) 2022-056536

(51) Int. Cl. A01C 21/00; A01B 79/00; G06T 7/00

(52) U.S. Cl. CPC A01C 21/005; A01B 79/005; A01C 21/007; G06T 7/0014; G06T 2207/30188

(57) ABSTRACT

A user terminal serving as a farming field information management device includes an imaging unit configured to capture an image, a display unit configured to display a captured image, a map information acquisition unit configured to acquire map information generated on the basis of crop-related information related to a crop in a farming field and position information indicating a growth location of the crop, a display control unit configured to allow the display unit to display the acquired map information superimposed in accordance with the imaging direction of the imaging unit on the captured image, and a data correction unit configured to correct the map information on the basis of the map information and the captured image displayed on the display unit.

### CROSS REFERENCE TO RELATED APPLICATIONS

This application claims the benefit of priority to Japanese Patent Application Number 2022-056536 filed on Mar. 30, 2022. The entire contents of the above-identified application are hereby incorporated by reference.

### TECHNICAL FIELD

The present disclosure relates to a farming field information management device, a farming field information management system, a farming field information management method, and a storage medium storing a farming field information management program that can be applied to managing a growth state of a crop in a farming field.

### BACKGROUND

Efficient farming operations require management of crop growth. What is needed is an efficient method for determining farming field information and actions that may be beneficial based on the farming field information.

### SUMMARY

A technique for creating a fertilization map for a farming field has been disclosed. This technique involves creating a fertilization map that indicates amounts of fertilizer for different locations in the farming field on the basis of growth data indicating growth states of crops and position data indicating growth locations of the crops (for example, refer to JP 2017-184640 A). In the technique of JP 2017-184640 A, the position data and growth data are gathered by a tractor equipped with a global positioning system (GPS) device and a growth sensor and are used for calculating growth states of the crops at different locations in the farming field when the tractor moves through the farming field.

As discussed above, in the technique of JP 2017-184640 A, the position data and growth data are acquired by a vehicle, usually a tractor, which can perform the global sensing of the farming field. The GPS device and growth sensor on the vehicle might have low accuracy, which can cause deviation between the acquired data and the actual growth states of the crop at different locations in the farming field. For example, the crop may actually be growing slowly while the data indicates that the crop is growing well, or the crop may actually be growing well while the data indicates that the crop is growing slowly. Such deviation between the acquired data and the actual states in a fertilization map can result in improper spreading of fertilizer. In addition, to correct the deviation, it is inefficient to conduct re-sensing of the entire faming field, which can cause another deviation.

In light of this, an object of the disclosure is to provide a farming field information management device, a farming field information management system, a farming field information management method, and a storage medium storing a farming field information management program, that allow a user to easily check for deviation between acquired position data and growth data of a farming field and an actual state of a crop, and easily correct such deviation.

To achieve the object discussed above, some embodiments provide a farming field information management device. The farming field information management device includes an imaging unit, a display unit, a map information acquisition unit, a display control unit, and a correction unit. The imaging unit is configured to capture an image. The display unit is configured to display a captured image captured by the imaging unit. The map information acquisition unit is configured to acquire map information generated on the basis of crop-related information related to a crop in a farming field and position information indicating a growth location of the crop. The display control unit is configured to allow the display unit to display the map information acquired by the map information acquisition unit superimposed in accordance with the imaging direction of the imaging unit on the captured image. The correction unit is configured to correct the map information on the basis of the map information and the captured image displayed on the display unit.

Further, to achieve the object discussed above, some embodiments provide a farming field information management system. The farming field information management system includes an imaging unit, a display unit, a map information acquisition unit, a display control unit, and a correction unit. The imaging unit is configured to capture an image. The display unit is configured to display a captured image captured by the imaging unit. The map information acquisition unit is configured to acquire map information generated on the basis of crop-related information related to a crop in a farming field and position information indicating a growth location of the crop. The display control unit is configured to allow the display unit to display the map information acquired by the map information acquisition unit superimposed in accordance with the imaging direction of the imaging unit on the captured image. The correction unit is configured to correct the map information on the basis of the map information and the captured image displayed on the display unit.

Further, to achieve the object described above, some embodiments provide a farming field information management method. The farming field information management method includes using a computer to perform an imaging step of capturing an image; an acquisition step of acquiring map information generated on the basis of crop-related information related to a crop in a farming field and position information indicating a growth location of the crop; a display control step of allowing a display unit to display the map information acquired in the acquisition step superimposed in accordance with the imaging direction of the imaging unit on a captured image captured in the imaging step; and a correction step of correcting the map information on the basis of the map information and the captured image displayed on the display unit in the display control step.

Further, to achieve the object described above, some embodiments provide a storage medium storing a farming field information management program. The storage medium is a storage medium storing a farming field information management program for causing a computer to execute: an imaging step of capturing an image; an acquisition step of acquiring map information generated on the basis of crop-related information related to a crop in a farming field and position information indicating a growth location of the crop; a display control step of allowing a display unit to display the map information acquired in the acquisition step superimposed in accordance with the imaging direction of the imaging unit on a captured image captured in the imaging step; and a correction step of correcting the map information on the basis of the map information and the captured image displayed on the display unit in the display control step.

According to the disclosure, a user can easily check for deviation between acquired position data and growth data of a farming field and an actual state of a crop, and easily correct such deviation.

### BRIEF DESCRIPTION OF DRAWINGS

FIG. 1 is an overall configuration diagram illustrating a farming field information management system.

FIG. 2 is a control block diagram illustrating a farming field information management system.

FIG. 3 is a sequence diagram illustrating the flow of farming field information management control executed by the farming field information management system.

FIG. 4 is a simplified diagram illustrating an example of an AR display image displayed on a display unit of a user terminal.

### DESCRIPTION OF EMBODIMENTS

Embodiments of the present disclosure will be described below with reference to the drawings.

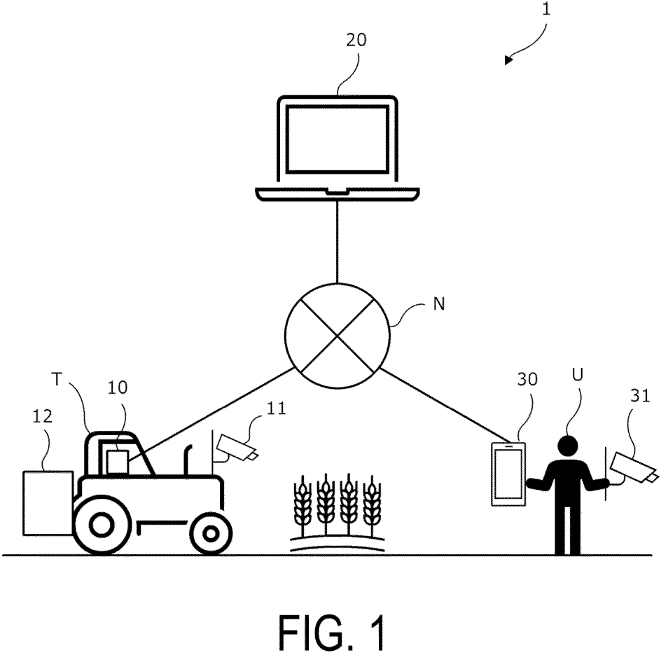

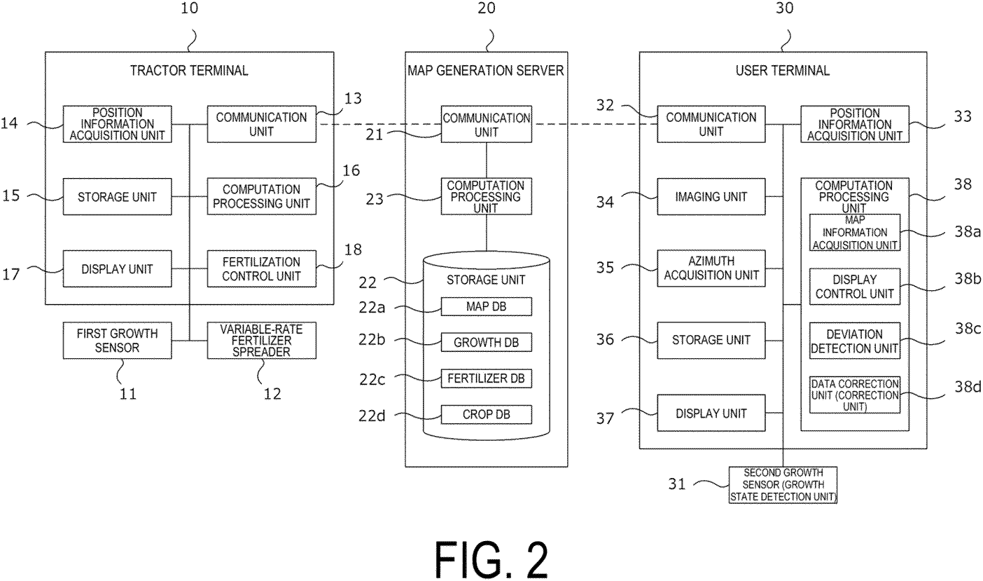

FIG. 1 is an overall configuration diagram illustrating a farming field information management system 1 according to an embodiment of the disclosure. FIG. 2 is a control block diagram illustrating the farming field information management system 1. The overall configuration of the farming field information management system 1 and the configuration of a control system according to an embodiment of the disclosure will be described with reference to FIGS. 1 and 2. The “farming field” of the present embodiment is described by using, as an example, a farm for growing crops such as rice, wheat, barley, and vegetables. The type of crop is not limited and may be of another plant.

The farming field information management system 1 primarily includes a tractor terminal 10 mounted on a tractor T, a map generation server 20, and a user terminal 30 used by a user U. The tractor terminal 10, the map generation server 20, and the user terminal 30 are communicably connected to each other via a network N. The network N is implemented by a typical communication network, for example, the Internet. For simplicity of description, in the present embodiment, one tractor terminal 10 and one user terminal 30 are communicably connected to one map generation server 20. However, a plurality of each of these devices may be applicable.

The tractor T is a mobile body that carries out fertilization work of spreading fertilizer while moving through a farming field. The tractor T is equipped with a first growth sensor 11 and a variable-rate fertilizer spreader 12 for a tractor.

The first growth sensor 11 measures the amount of nutrient content in a crop using a non-contact method. This measurement allows the user U to check the growth state of the crop. As an example of the non-contact method, the first growth sensor 11 of the present embodiment irradiates leaves of the crop with two types of laser light (measurement light) having different wavelengths. Then, the first growth sensor 11 measures the amount of a growth-related nutrient content on the basis of the state of the reflected light, including reflectance and the amount of light. Using the measured amount of nutrient content as an indicator of the growth state allows the user U to classify growth states. For simplicity of description, only one first growth sensor 11 is illustrated in the drawings. However, the tractor T may include a plurality of the first growth sensors 11.

The variable-rate fertilizer spreader 12 spreads fertilizer to a farming field. The variable-rate fertilizer spreader 12 can vary the amount of fertilizer spread (amount of fertilizer) in response to control input to the tractor terminal 10. In other words, the variable-rate fertilizer spreader 12 can spread fertilizer in an amount determined in accordance with the growth state of the crop at any given location in the farming field.

The user U is, for example, a person involved in farming for the farming field or an administrator who manages the map generation server 20. The user U in the present embodiment carries, along with the user terminal 30, a second growth sensor 31 (growth state detection unit). The second growth sensor 31 has the same function as that of the first growth sensor 11, and is a portable, handheld sensor smaller than the first growth sensor 11.

In the farming field information management system 1 configured as discussed above, the tractor T globally detects growth states of the crop by using the first growth sensor 11 while moving through the entire farming field. The tractor T transmits information related to the growth states of the crop in the farming field, which has been detected by the first growth sensor 11 (hereinafter also referred to as “growth data”), along with position information related to the crop to be detected (hereinafter also referred to as “position data”), to the map generation server 20. The map generation server 20 generates map information related to the crop on the basis of the acquired growth data and position data, and then transmits this map information to the user terminal 30. The user U can use the map information received at the user terminal 30 to observe the state of the crop. The user U can also use the user terminal 30 of the present embodiment to correct a deviation between the map information and the actual state of the crop.

FIG. 2 illustrates a detailed control configuration of the tractor terminal 10, the map generation server 20, and the user terminal 30.

The tractor terminal 10 is an information processing terminal equipped with a computer that can run application software (programs). The tractor terminal 10 need not necessarily be a dedicated terminal for the purpose, and may be a general-purpose terminal including a smartphone, a feature phone, a tablet, a personal computer, and a wearable terminal such as an eyeglass-type device or a watch-type device. The tractor terminal 10 is communicably connected to the first growth sensor 11 and the variable-rate fertilizer spreader 12 in a wired or wireless manner. Further, the tractor terminal 10 includes a communication unit 13, a position information acquisition unit 14, a storage unit 15, a computation processing unit 16, a display unit 17, and a fertilization control unit 18.

The communication unit 13 of the tractor terminal 10 is a communication module that enables the tractor terminal 10 to communicate with the map generation server 20 via the network N. This communication protocol is not limited to any particular one.

The position information acquisition unit 14 of the tractor terminal 10 acquires position information of the tractor T, and is implemented by, for example, a global navigation satellite system (GNSS) receiver, such as a global positioning system (GPS) receiver. The position information includes at least latitude and longitude information. Since the tractor T and the first growth sensor 11 have a fixed positional relationship, the position information acquisition unit 14 can calculate the position data of a crop detected by the first growth sensor 11 by using the position information of the tractor T acquired by the position information acquisition unit 14.

The storage unit 15 of the tractor terminal 10 is a storage device or a storage medium including one or more hard disk drives (HDDs), solid state drives (SSDs), and flash memories. The storage unit 15 stores various information including the growth data detected by the first growth sensor 11 and the position data acquired by the position information acquisition unit 14, and programs to be executed by the computation processing unit 16 discussed below.

The computation processing unit 16 of the tractor terminal 10 executes functions and/or methods realized by codes or instructions included in programs. The computation processing unit 16 is an integrated circuit including a central processing unit (CPU), a microprocessor unit (MPU), a graphics processing unit (GPU), a microprocessor, a processor core, a multiprocessor, an application specific integrated circuit (ASIC), or a field programmable gate array (FPGA), and the integrated circuit forming a logic circuit or a dedicated circuit may execute each process disclosed in the embodiments. These circuits may be implemented by one or more integrated circuits, and one integrated circuit may execute the plurality of processes described in each embodiment. The computation processing unit 16 may include a main storage unit that temporarily stores a program read from the storage unit 15 and provides a workspace for the computation processing unit 16.

The computation processing unit 16 stores, the growth data detected by the first growth sensor 11 and the position data of the crop acquired by the position information acquisition unit 14 in association with each other in the storage unit 15, for example. The computation processing unit 16 also transmits the growth data and the position data to the map generation server 20 via the communication unit 13. The computation processing unit 16 also acquires map information, such as a growth map and a fertilization map described below, from the map generation server 20 via the communication unit 13, and storing this map information in the storage unit 15.

The display unit 17 of the tractor terminal 10 is a device that can display various information. The display unit 17 may be a flat display, such as a liquid crystal display or an organic light-emitting diode (OLED) display, a curved display, a folding screen provided in a foldable terminal, a head-mounted display, or a display device that can project images onto an object by using a small projector. The display unit 17 of the present embodiment is a touch panel, for example, which also functions as an input interface that receives an input operation from a driver of the tractor T.

The fertilization control unit 18 controls the variable-rate fertilizer spreader 12. The fertilization control unit 18 controls the amount of fertilizer to be spread by the variable-rate fertilizer spreader 12. The fertilization control unit 18 sets up the amount of fertilizer according to each location in the farming field on the basis of the fertilization map which has been stored in the storage unit 15, and controls the variable-rate fertilizer spreader 12 to spread the fertilizer in the set amount.

The map generation server 20 is a server device, which is a computer that can run application software (programs). The map generation server 20 includes a communication unit 21, a storage unit 22, and a computation processing unit 23.

The communication unit 21 of the map generation server 20 is a communication module that enables the map generation server 20 to communicate with the tractor terminal 10 and the user terminal 30 via the network N. This communication protocol is not limited to any particular one.

The storage unit 22 of the map generation server 20 is a storage device or a storage medium, such as one or more HDDs, SSDs, or flash memories, and constructs various databases (hereinafter referred to as “DB”). For example, the storage unit 22 includes a map DB 22a, a growth DB 22b, a fertilizer DB 22c, and a crop DB 22d.

The storage unit 22 stores map information including the position information of the farming field in the map DB 22a. The storage unit 22 stores, in the growth DB 22b, the growth data detected by the first growth sensor 11 or the second growth sensor 31, the position data associated with the growth data, the growth map, and other data. The storage unit 22 stores past fertilization history, such as the type, amount, spread area, and the period when the fertilizer is spread over the farming field, the fertilization map generated by the computation processing unit 23, and other data in the fertilizer DB 22c. The storage unit 22 stores information related to the crop itself, such as the type of crop grown in the farming field and the type and amount of fertilizer appropriate for the growth state in the crop DB 22d.

The computation processing unit 23 (map generation unit) of the map generation server 20 has a configuration similar to that of the computation processing unit 16 of the tractor terminal 10 and is, for example, a CPU dedicatedly configured for a server device in the present embodiment. The computation processing unit 23 generates various maps indicating crop-related information related to the crop. The maps generated by the computation processing unit 23 include the growth map indicating the growth state of the crop at different locations in the farming field and the fertilization map in which different amounts of fertilizer are set for different locations in the farming field on the basis of the growth map.

The map information configures the range of the farming field and divides the farming field into a plurality of unit sections that have been predetermined. That is, the map information is made up of a set of predetermined unit sections, which are typically a set of square sections having the same size in a grid manner to separate the map (i.e., grid units). The unit section is not limited to a square shape and can be any shape that divides the display area into a plurality of consecutive unit sections without gaps, such as a hexagon or triangle shape. The unit section is also not particularly limited to any size. Each unit section intersecting the boundary line indicating the edge of the farming field may have a shape with a portion that protrudes beyond the boundary line or a shape in which a portion of the grid is missing so as not to protrude beyond the boundary line. Each unit section includes position information on the map.

The computation processing unit 23 uses the information of the various DBs stored in the storage unit 22 to generate the various maps. For example, the computation processing unit 23 generates the growth map indicating a degree of growth in each unit section of the farming field on the basis of the map information in the map DB 22a, and the growth data and the position data, both of which have been recorded in the growth DB 22b. The computation processing unit 23 generates the fertilization map indicating the amount of fertilizer for each unit section of the farming field on the basis of the growth map, the crop information in the crop DB 22d, and the fertilization history in the fertilizer DB 22c. The computation processing unit 23 can also update the various DBs as appropriate.

The user terminal 30 is an information processing terminal for a user, and is equipped with a computer that can run application software (programs). The user terminal 30 includes a smartphone, a feature phone, a tablet, a personal computer, or a wearable terminal such as an eyeglass-type device or a watch-type device. The user terminal 30 is communicably connected to the second growth sensor 31 in a wired or wireless manner. The user terminal 30 includes a communication unit 32, a position information acquisition unit 33, an imaging unit 34, an azimuth acquisition unit 35, a storage unit 36, a display unit 37, and a computation processing unit 38.

The communication unit 32 of the user terminal 30 is a communication module that enables the user terminal 30 to communicate with the map generation server 20 via the network N. This communication protocol is not limited to any particular one.

The position information acquisition unit 33 of the user terminal 30 acquires position information of the user terminal 30 and is, for example, a GNSS receiver, such as a GPS receiver. The position information includes at least latitude and longitude information.

The imaging unit 34 is a camera that captures an image. The imaging unit 34 is provided on the rear side of the user terminal 30, that is, the side of the user terminal 30 opposite to the display unit 37. The display unit 37 can display the image captured by the imaging unit 34 (hereinafter, also referred to as “captured image”), which may be a moving image or a still image.

The azimuth acquisition unit 35 detects geomagnetism with a magnetic sensor to calculate the azimuth of the user terminal 30. The azimuth acquisition unit 35 is, for example, an electronic compass. The azimuth acquisition unit 35 can acquire the azimuth of the imaging direction of the imaging unit 34, that is, the azimuth of which orientation the user U sees through the display unit 37.

The storage unit 36 of the user terminal 30 is a storage device or a storage medium, such as one or more HDDs, SSDs, or flash memories. The storage unit 36 stores the growth information of the crop detected by the second growth sensor 31, the position information acquired by the position information acquisition unit 33, and the captured image captured by the imaging unit 34, as well as the azimuth information of the captured image, the program run by the computation processing unit 38 described below, and other programs. The storage unit 36 also stores various maps, such as growth map and fertilization map, acquired from the map generation server 20 via the communication unit 32.

The display unit 37 of the user terminal 10 is a device that can display various information. Examples of the display unit 37 include a flat display, such as a liquid crystal display or an OLED display, a curved display, a folding screen provided in a foldable terminal, a head-mounted display, or a display device that can project images onto an object using a small projector. The display unit 37 of the present embodiment is, for example, a touch panel that also functions as an input interface configured to receive an input operation from the user U.

The computation processing unit 38 of the user terminal 30 has a configuration similar to that of the computation processing unit 16 of the tractor terminal 10. For example, in the present embodiment, the computation processing unit 38 is a CPU . The computation processing unit 38 has functions such as displaying an augmented reality (AR) image of the various maps on the display unit 37, detecting deviation between the map information and the actual growth state, and correcting the deviation. The computation processing unit 38 includes, as functions, a map information acquisition unit 38a, a display control unit 38b, a deviation detection unit 38c, and a data correction unit 38d.

The map information acquisition unit 38a acquires the map information from the map generation server 20 via the communication unit 32. In a case where the map information is stored in the storage unit 36 of the user terminal 30, the map information acquisition unit 38a may acquire the map information from the storage unit 36.

The display control unit 38b has an AR display function of displaying, on the display unit 37, the map information acquired by the map information acquisition unit 38a superimposed in accordance with the imaging direction of the imaging unit 34 on the captured image. The display control unit 38b is not limited to AR display and need only be compatible with so-called extended reality (XR) display, such as mixed reality (MR) display.

The display control unit 38b uses the position information of the user terminal 30 acquired sequentially by the position information acquisition unit 33 and the orientation of the imaging unit 34 acquired by the azimuth acquisition unit 35 to generate a map image of the corresponding visual range in the map information acquired by the map information acquisition unit 38a. The display control unit 38b displays, on the display unit 37, the map image superimposed on the captured image in an AR display image. Note that the map information in the present embodiment can be switched in response to an operation by the user U to show one of these between AR display based on the growth map and AR display based on the fertilization map.

The deviation detection unit 38c uses the state of a crop by image analysis on the crop in the captured image to detect deviation between the state of the crop detected by the image analysis and the state of the crop based on the map information, such as the growth map. The image analysis is performed by a learned model obtained by machine learning, such as deep learning, which has been trained using images corresponding to the growth states of each type of crop as learning data. This learned model obtained by machine learning can receive input of an image and output the growth state of each crop in the image. The growth state of the crop thus output from the learned model is indicated by, for example, a numerical value corresponding to the degree of growth. For example, the degree of growth is indicated on a scale from 0 to 100, respectively representing a state before growth and a fully grown state. Note that the method of image analysis is not limited to a method based on a learned model, and any method is possible which can output a growth state of a crop from an image.

The deviation detection unit 38c also issues an alert when the detected deviation meets a predetermined condition for the alert. A non-limiting example of the predetermined condition is whether the difference between the numerical value of the degree of growth output by the image analysis and the numerical value of the degree of growth based on the growth map of the crop at the same position or in the same range on the map exceeds a predetermined value. If the difference exceeds the predetermined value, the deviation detection unit 38c will determine that the deviation between the actual growth state of the crop and the growth state on the map is large, and issue an alert. This alert issued by the deviation detection unit 38c includes displaying an alert on the display unit 37 and/or emitting an alert sound.

The data correction unit 38d corrects the map information using the growth state of the crop detected by the second growth sensor 31 and the position information of the crop calculated on the basis of the position information acquired by the position information acquisition unit 33 of the user terminal 30. As an example of another configuration, the second growth sensor including the position information acquisition unit may acquire the position information of the crop.

As notified by an AR image or the alert issued by the deviation detection unit 38c, the user U uses the second growth sensor 31 to check a growth state of the crop for which the deviation was detected. The data correction unit 38d associates the growth data detected by the second growth sensor 31 with the position data corresponding to the place where the crop is grown to generate correction information for the growth data in the map information, and transmits this correction information to the map generation server 20 via the communication unit 32. The correction information for the growth data is growth data that corresponds to the position information at the location where the deviation is to be corrected and is detected using the second growth sensor 31. In some embodiments, the user U may select one piece of the detected growth data. Once selected, the data correction unit 38d may also use this data for generating the correction information. After receiving the correction information, the map generation server 20 corrects the map information according to the correction information and updates the databases.

### Process Flow

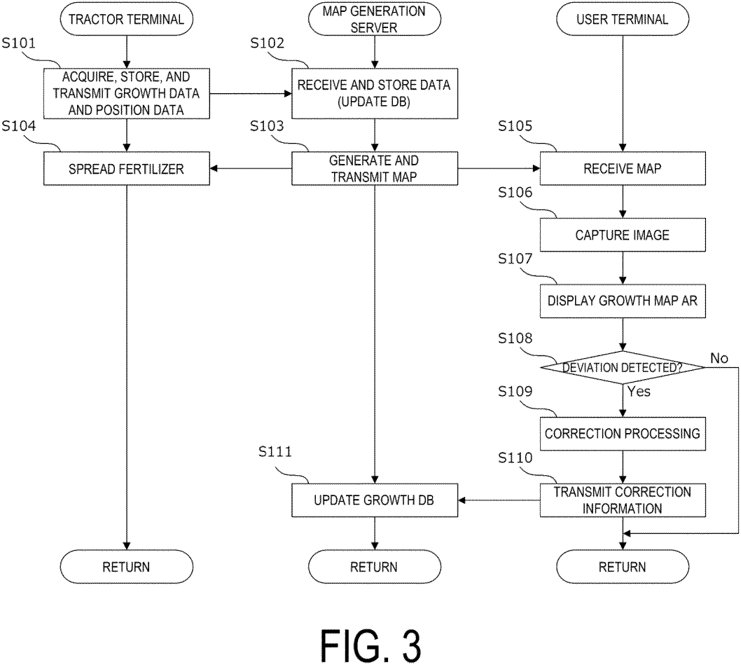

Next, FIG. 3 illustrates the flow of a farming field information management method executed by a computer. FIG. 3 is a sequence diagram illustrating the flow of farming field information management control executed by the farming field information management system 1. The farming field information management method is implemented by a farming field information management program executed by the computer.

First, in step S101, the computation processing unit 16 of the tractor terminal 10 stores, in the storage unit 15, growth data of the crop detected by the first growth sensor 11 and position data of the crop acquired by the position information acquisition unit 14. Then, the computation processing unit 16 transmits the growth data and position data to the map generation server 20 via the communication unit 13.

In step S102, the computation processing unit 23 of the map generation server 20 stores, in the growth DB 22b of the storage unit 22, the growth data and position data received from the tractor terminal 10 in association with each other, thereby updating the database.

In step S103, the computation processing unit 23 of the map generation server 20 generates the map information, including the growth map and fertilization map of the crop, by using data in the various DBs stored in the storage unit 22. Then, the computation processing unit 23 transmits the map information to the tractor terminal 10 and the user terminal 30 via the communication unit 21.

In step S104, the fertilization control unit 18 of the tractor terminal 10 controls the variable-rate fertilizer spreader 12 on the basis of the received fertilization map and spreads the fertilizer.

Meanwhile, in step S105, the map information acquisition unit 38a of the user terminal 30 acquires the map information received from the map generation server 20 via the communication unit 32 (acquisition step of the map information).

In step S106, the imaging unit 34 of the user terminal 30 captures an image (imaging step). At this time, the user U directs the imaging unit 34 toward the crop in the farming field so that the crop is captured in the image.

In step S107, the display control unit 38b of the user terminal 30 causes the display unit 37 to display the map image superimposed on the captured image in an AR image (display control step). The captured image has been captured in step S106, and the map image is based on the map information corresponding to the captured image and acquired in step S105. The user U views the AR image to check the state of the crop.

In step S108, the deviation detection unit 38c of the user terminal 30 determines whether a deviation has been detected between the state of the crop acquired by the image analysis of the captured image captured in step S106 and the state of the crop based on the map information (deviation detection step). This determination is made based on whether the predetermined condition discussed above is met. If the determination result is true (Yes), which means a deviation is detected, the computation processing unit 38 will proceed to step S109. At this time, the deviation detection unit 38c issues an alert. On the other hand, if the determination result is false (No), which means a deviation is not detected, the computation processing unit 38 will return the routine to step S105 with no further processing.

In step S109, the data correction unit 38d of the user terminal 30 makes a correction (correction step). At this time, the data correction unit 38d generates correction information, which is information for the crop related to the deviation, based on the growth data detected by the user U using the second growth sensor 31 and the position data acquired by the position information acquisition unit 33.

In step S110, the data correction unit 38d of the user terminal 30 transmits the correction information generated in step S109 to the map generation server 20 via the communication unit 32.

In step S111, the computation processing unit 23 of the map generation server 20 stores, in the growth DB 22b of the storage unit 22, the growth data and position data received from the user terminal 30 in association with each other, thereby updating the database.

With the farming field information management system 1 according to the present embodiment as discussed above, the user U can locally measure the farming field one more time to correct the growth data acquired by the tractor terminal 10 via global sensing. Additionally, the correction information generated at the user terminal 30 side is processed with priority over the growth data acquired by the tractor terminal 10 so that the growth data is not updated with additional growth data acquired by the tractor T. The tractor T can then carry out fertilization work based on an updated and more precise fertilization map, thus improving the accuracy of the fertilization work.

### Display Example

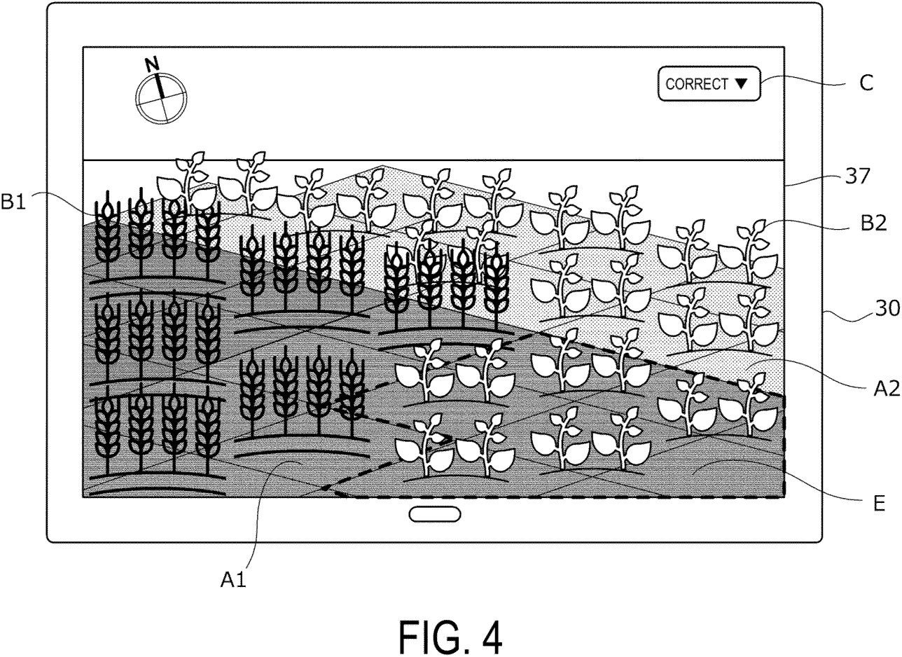

FIG. 4 illustrates, in a simplified manner, an AR display image displayed on the display unit 37 of the user terminal 30.

As illustrated in FIG. 4, the AR display image of the present embodiment shows the growth map information in unit sections of squares or rhombuses (rhombuses are used in FIG. 4) superimposed on a captured image of the crop. In FIG. 4, the shading or color of each unit section indicates the degree of growth: a darker-shaded unit section indicates a higher degree of growth than a lighter-shaded unit section, that is, crops in a darker-shaded unit section have grown more than crops in a lighter-shaded unit section. Consequently, the growth map illustrated in FIG. 4 shows that crops in a first region A1 have grown more than crops in a second region A2. Assuming that there is a deviation between the state of the crops in the map information and the state of the actual crops, where a first crop B1 has grown more than a second crop B2, and some of the second crop B2 is present in the first region A1. In FIG. 4, the range where the second crop B2 is present in the first region A1 is surrounded by a bold dashed line and indicated as a deviation region E.

The deviation detection unit 38c displays this deviation region E as an alert. The deviation detection unit 38c issues the alert for the deviation region E, for example, in a different way from that of the first region A1 and the second region A2. In some embodiments, as illustrated in FIG. 4, the data correction unit 38d may display a correction operation button C on the AR image. When the user U clicks the correction operation button C, the computation processing unit 23 corrects the growth data of the deviation region E with the correction information produced by the data correction unit 38d.

### Effects

As discussed above, the farming field information management system 1 according to the present embodiment displays an AR image on the user terminal 30, which allows the user to correct the map information. The AR image includes map information superimposed on a captured image, and the map information is generated on the basis of crop-related information (growth data) for a crop in a farming field and position information (position data) indicating the growth locations of the crop. This configuration allows the user U to perform local sensing again to correct the growth data easily, which have been acquired by the tractor T using the tractor terminal 10 via global sensing.

Further, the deviation detection unit 38c analyses the captured image to detect the state of the crop and detect deviation between the state of the crop determined by the image analysis and the state of the crop based on the map information. As a result, deviation can be easily detected.

In particular, the deviation detection unit 38c of the present embodiment detects the growth state of a crop by image analysis, as well as detects deviation between the growth state and the growth state of the crop based on the growth map. Thus, deviation between the growth states of a crop can be easily detected.

Furthermore, the deviation detection can proactively notify the user U when deviation occurs because the deviation detection unit 38c issues an alert when the deviation meets the predetermined condition.

The data correction unit 38d then corrects the map information by using the growth data obtained by sensing again with the second growth sensor 31 and the position information corresponding to the growth data. This allows the user U to easily correct deviation between the state of a crop determined by image analysis and the state of the crop based on the map information.

As may be appreciated from the foregoing discussion, the user terminal 30 (farming field information management device), farming field information management system 1, farming field information management method, and farming field information management program according to the present embodiment allow a user to easily check for deviation between a growth state based on acquired position data and growth data of a farming field and an actual growth state, and easily correct the deviation.

Although an embodiment of the present disclosure has been discussed above, aspects of the present disclosure are not limited to this embodiment.

While the farming field information management system 1 according to the embodiment described above is applied to fertilization work carried out by the tractor T, the farming field information management system 1 may be applied to other works, such as spraying or sprinkling an agrochemical or pesticide. In spraying or sprinkling of an agrochemical or pesticide, an agrochemical application map corresponding to the growth map is generated instead of the fertilization map.

Further, while the deviation detection unit 38c of the embodiment described above detects deviation between growth states, the deviation between states of a crop is not limited to the growth state. In some embodiments, for example, the deviation detection unit may detect the type of crop by performing image analysis on the crop in a captured image, and then detect deviation between the type of crop determined by the image analysis and the type of crop based on the map information. The deviation detection unit may then issue an alert according to the deviation. This deviation can also be corrected in response to a user operation. This configuration also allows a user to easily check for deviation from the actual state of the crop, and easily correct such deviation.

Further, in the embodiment described above, the user U corrects the deviation using the second growth sensor 31, but the deviation correction method is not limited to this. For example, the data correction unit may correct the map information on the basis of the map information and captured image displayed on the display unit. The data correction unit automatically corrects, on the basis the deviation of the growth state calculated by the deviation detection unit, the map information to reduce the deviation. For example, when 80 is the degree of growth of the crop determined by image analysis and 50 is the degree of growth of the crop on the growth map, the deviation is 30. In this case, the data correction unit corrects the deviation to bring the degree of growth of the crop on the growth map to 80. Alternatively, when there is a deviation in the type of crop, the data correction unit corrects the crop type on the map to the crop type determined by image analysis. Correcting in this way can allow the farming field information management system 1 to automatically correct the map information and more easily correct the deviation.

Further, as a modified example of the embodiment discussed above, the data correction unit may correct the map information in response to a user operation. In FIG. 4, the data correction unit displays the correction operation button on the AR display and corrects the deviation in accordance with a tap operation on the correction operation button performed by the user. However, the operation on the correction operation button is not limited to the tap operation and may be an operation performed via an input device, such as a mouse or a keyboard. In this case, the deviation may also be detected visually by the user. That is, the deviation detection unit receives an operation from the user who detected the deviation. Note that, in this case, issuing an alert is unnecessary.

For example, the flow of processing in the modified example is described with reference to the flowchart in FIG. 3. In step S107, the user U views the AR image displayed on the display unit 37 of the user terminal 30 and compares the actual state of the crop and the state of the crop based on the map information.

In step S108, the user U determines whether deviation exists between the actual state of the crop and the state of the crop based on the map information. If the determination result is false (No), the computation processing unit 38 returns the routine with no further processing. If the determination result is true (Yes), that is, if the deviation detection unit 38c receives a deviation detection operation from the user U, the computation processing unit 38 proceeds to step S109.

In step S109, the data correction unit 38d of the user terminal 30 corrects the map information in response to the user operation, and transmits the correction information to the map generation server 20 in the subsequent step S110.

In this modified example, neither image analysis for deviation detection nor issuing an alert are required. Since the accuracy of this image analysis may not be high in some cases, such a visual deviation detection by the user allows a deviation from the actual state to be easily checked with a simpler configuration and the deviation to be easily corrected. In addition, the deviation detection unit 38c may be configured to freely switch between deviation detection by image analysis and deviation detection by the user U in response to a user operation.

Furthermore, in the embodiment described above, while the user terminal 30 includes the imaging unit 34, the display unit 37, the map information acquisition unit 38a, the display control unit 38b, and the data correction unit 38d, some of these components may be included in another device in the farming field information management system 1. For example, the map generation server may include the deviation detection unit and the data correction unit provided that the AR display generated by the display control unit can be transmitted to the map generation server. This configuration also achieves the same effects as those of the embodiment described above.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A farming field information management device, comprising:
an imaging unit configured to capture an image;
a display unit configured to display a captured image captured by the imaging unit;
a map information acquisition unit configured to acquire map information generated on the basis of crop-related information related to a crop in a farming field and position information indicating a growth location of the crop;
a display control unit configured to allow the display unit to display the map information acquired by the map information acquisition unit superimposed in accordance with the imaging direction of the imaging unit on the captured image; and
a correction unit configured to correct the map information on the basis of the map information and the captured image displayed on the display unit.

2. The farming field information management device according to claim 1, further comprising:
a deviation detection unit configured to detect a state of the crop by subjecting the crop in the captured image to image analysis, and detect a deviation between the state of the crop determined by the image analysis and a state of the crop based on the map information.

3. The farming field information management device according to claim 2, wherein the deviation detection unit detects a growth state of the crop by subjecting the crop in the captured image to image analysis, and detects a deviation between the growth state of the crop determined by the image analysis and a growth state of the crop based on the map information.

4. The farming field information management device according to claim 2, wherein the deviation detection unit detects a type of the crop by subjecting the crop in the captured image to image analysis, and detects a deviation between the type of the crop determined by the image analysis and a type of the crop based on the map information.

5. The farming field information management device according to claim 2, wherein the deviation detection unit issues an alert when the deviation meets a predetermined condition.

6. The farming field information management device according to claim 2, wherein the correction unit automatically corrects, on the basis of the deviation of a growth state detected by the deviation detection unit, the map information to reduce the deviation.

7. The farming field information management device according to claim 1, further comprising:
a growth state detection unit configured to detect a growth state of the crop; and
a position information acquisition unit configured to acquire position information of the crop subject to growth state detection by the growth state detection unit, wherein
the correction unit corrects the map information by using the growth state of the crop detected by the growth state detection unit and the position information of the crop acquired by the position information acquisition unit.

8. The farming field information management device according to claim 1, wherein the correction unit is configured to correct the map information in response to a user operation.

9. A farming field information management system, comprising:
an imaging unit configured to capture an image;
a display unit configured to display a captured image captured by the imaging unit;
a map information acquisition unit configured to acquire map information generated on the basis of crop-related information related to a crop in a farming field and position information indicating a growth location of the crop;
a display control unit configured to allow the display unit to display the map information acquired by the map information acquisition unit superimposed in accordance with the imaging direction of the imaging unit on the captured image; and
a correction unit configured to correct the map information on the basis of the map information and the captured image displayed on the display unit.

10. A farming field information management method, comprising:
using a computer to perform:
an imaging step of capturing an image,
an acquisition step of acquiring map information generated on the basis of crop-related information related to a crop in a farming field and position information indicating a growth location of the crop,
a display control step of allowing a display unit to display the map information acquired in the acquisition step superimposed in accordance with the imaging direction of an imaging unit on a captured image captured in the imaging step, and
a correction step of correcting the map information on the basis of the map information and the captured image displayed on the display unit in the display control step.

11. A storage medium storing a farming field information management program for causing a computer to execute:
an imaging step of capturing an image;
an acquisition step of acquiring map information generated on the basis of crop-related information related to a crop in a farming field and position information indicating a growth location of the crop;
a display control step of allowing a display unit to display the map information acquired in the acquisition step superimposed in accordance with the imaging direction of an imaging unit on a captured image captured in the imaging step; and
a correction step of correcting the map information on the basis of the map information and the captured image displayed on the display unit in the display control step.
